(19) United States
(12) Patent Application Publication
(10) Pub. No.: US 2016/0374391 A1
(43) Pub. Date: Dec. 29, 2016

(54) ELECTRONIC CIGARETTE

(71) Applicant: KIMREE HI-TECH INC.,, Tortola (VG)

(72) Inventor: Qiuming LIU, Guangdong (CN)

(21) Appl. No.: 14/119,076

(22) PCT Filed: Sep. 3, 2013
(86) PCT No.: PCT/CN2013/082846

§ 371 Date: Nov. 20, 2013

(30) Foreign Application Priority Data
Aug. 14, 2013 (CN) 201320496487.8

(51) Int. Cl. A24F 47/00; H01R 4/06; H01R 4/02; H05B 3/03

(52) U.S. Cl. CPC A24F 47/008; H05B 3/03; H01R 4/06; H01R 4/029; H05B 2203/021

(57) ABSTRACT

There is provided in the present application an electronic cigarette, including an electric heating wire and an electrode. The electric heating wire is electrically conducted to the electrode via a conductor. In the electronic cigarette according to the present application, the electric heating wire is electrically conducted to the electrode via the conductor, instead of a copper sheet and a lead with smaller volumes. In this way, the problem of poor contact which is likely to occur in connection of various conductors could be avoided, so that a phenomenon of an unstable value of resistance in the circuit may be avoided, and emission of smoke becomes more even.

This application claims the benefit of priority to Chinese patent application No. 201320496487.8 titled “ELECTRONIC CIGARETTE” and filed with the Chinese State Intellectual Property Office on Aug. 14, 2013, the entire disclosure of which is incorporated herein by reference.

### FIELD OF THE INVENTION

The present application relates to the technical field of fittings of the electronic cigarette, and more specifically, to an electronic cigarette.

### BACKGROUND OF THE INVENTION

An electronic cigarette is a common emulation electronic product of cigarette, which mainly includes liquid storage cotton, an atomizer and a battery. The battery supplies electricity to the atomizer, which makes the atomizer heated, so that the liquid stored in the liquid storage cotton is vaporized to release smoke, thereby achieving an effect of emulation cigarette.

The atomizer includes an electric heating wire 01 electrically conducted to an electrode 03 of the electric cigarette via a lead 02. The electrode 03 is electrically conducted to the battery 04. The electric heating wire 01 generates heat under the action of electricity supplied by the battery 04. In the prior art, the electric heating wire 01 is electrically conducted to the lead 02 via a copper sheet with a smaller volume, with the lead 02 being connected to the copper sheet 05 by way of riveting, as shown in FIGS. 1 and 2.

In use of the above electrically conducted electronic cigarette, it is found that poor contact is prone to occur between the electric heating wire 01 and the lead 02 which are connected by the copper sheet 05, thus causing an unstable value of resistance in the circuit and an uneven heat emitted from the electric heating wire 01 in different time, and then influencing an even emission of the smoke. The practical effect is not ideal.

Thus, a problem to be solved presently by those skilled in the art is to further improve the using effect of the electronic cigarette.

### SUMMARY OF THE INVENTION

In view of this, there is provided in the present application an electronic cigarette which could further improve an emission evenness of smoke.

In order to achieve the above object, following technical solutions are provided in the present application:

An electronic cigarette includes an electric heating wire, an electrode, and a conductor electrically conducting the electric heating wire with the electrode. The conductor is fixed to the electric heating wire by way of riveting.

Preferably, in the electronic cigarette, the conductor is a strip-shaped or rod-shaped conductor, and has a riveting section provided with two wing pieces and connected to the electric heating wire. The two wing pieces are provided symmetrically and have a same structure.

Preferably, in the electronic cigarette, the wing piece is a tooth-shaped wing piece.

Preferably, in the electronic cigarette, the wing piece is a notch-shaped wing piece.

Preferably, in the electronic cigarette, the wing piece is a plate-shaped wing piece.

Preferably, in the electronic cigarette, the two wing pieces are provided in a V-shape on the conductor, and form therebetween an angle ranged from 20 degrees to 80 degrees.

Preferably, in the electronic cigarette, the conductor is a metal sheet or a metal tube. In the case of the metal sheet, the conductor has a thickness ranged from 0.1 millimeter to 0.5 millimeter.

Preferably, in the electronic cigarette, the electric heating wire and the conductor are connected by way of riveting.

Preferably, in the electronic cigarette, the conductor has an extending section connected to the electrode by way of welding or interference fit.

In the electronic cigarette according to the present application, the electric heating wire 1 is electrically conducted to the electrode 2 by using only the conductor 3, and the electric heating wire 1 and the conductor 3 are electrically conducted with each other by riveting, instead of using a copper sheet and a lead with smaller volumes. Such connection is firmer, so that a phenomenon of an unstable value of resistance in the circuit is avoided, and emission of smoke becomes more even.

### BRIEF DESCRIPTION OF THE DRAWINGS

In order to more clearly illustrate embodiments of the present application or technical solutions in the prior art, drawings required for the description of the embodiments or the prior art will be briefly introduced below. Apparently, the drawings described below simply relate to some embodiments of the present application, and those skilled in the art may obtain other drawings, based on the following drawings, without any creative work.

FIG. 1 is a structural schematic view of an electronic cigarette in the prior art;

FIG. 2 is a partial enlarged view of FIG. 1;

FIG. 3 is a structural schematic view of an electronic cigarette according to an embodiment of the present application;

FIG. 4 is an exploded view of the electronic cigarette;

FIG. 5 is a partial enlarged view of FIG. 4;

FIG. 6 is a structural schematic view of a conductor with sawtooth-shaped wing pieces;

FIG. 7 is a structural schematic view of a conductor with notch-shaped wing pieces; and

FIG. 8 is a structural schematic view of a conductor with plate-shaped wing pieces.

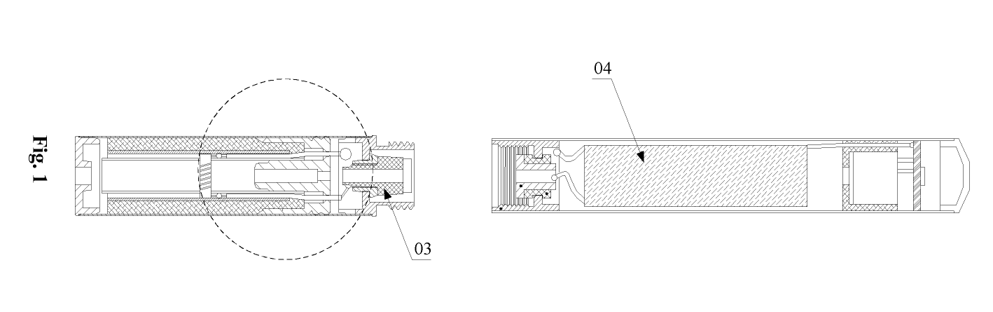

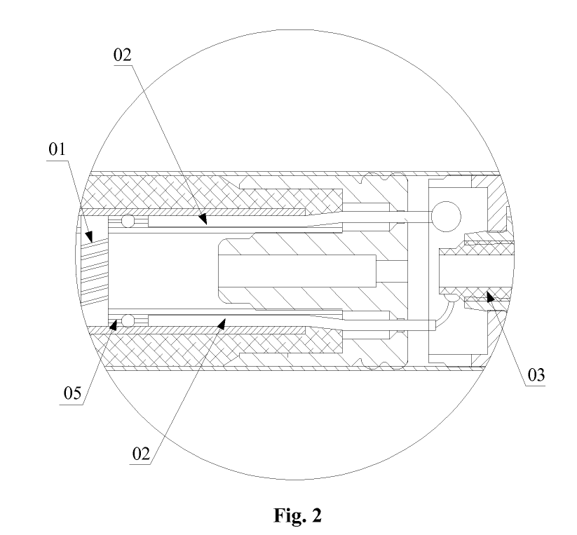

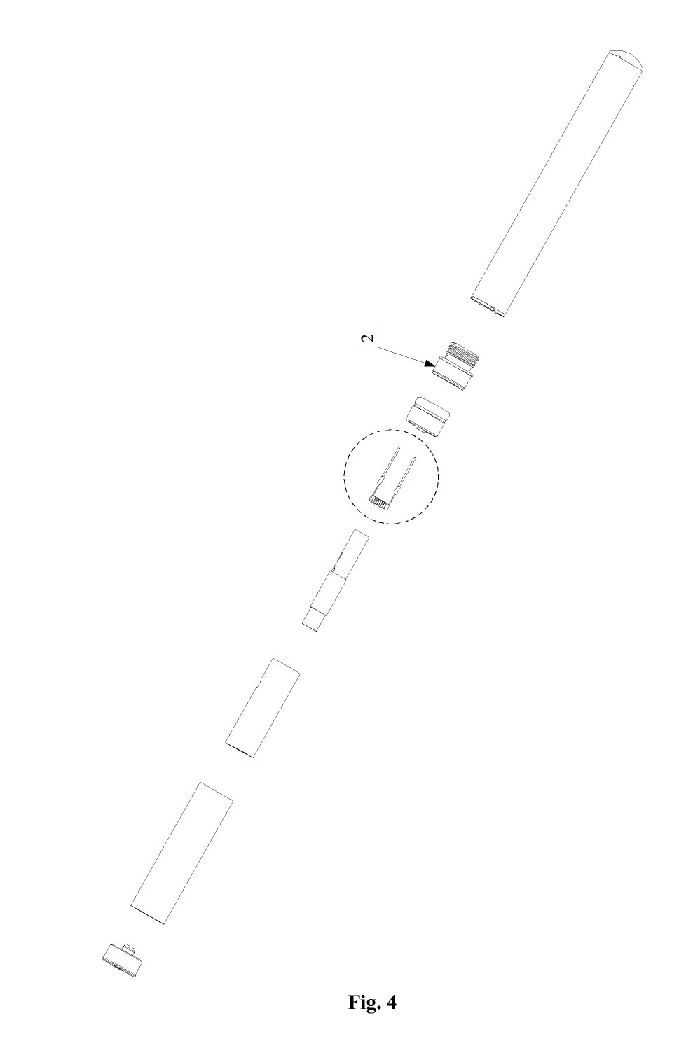

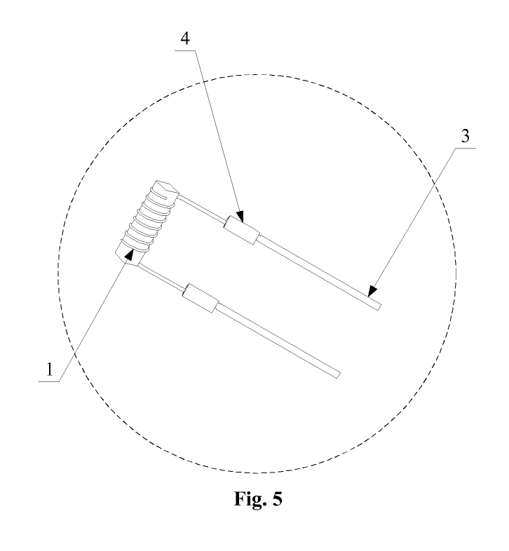

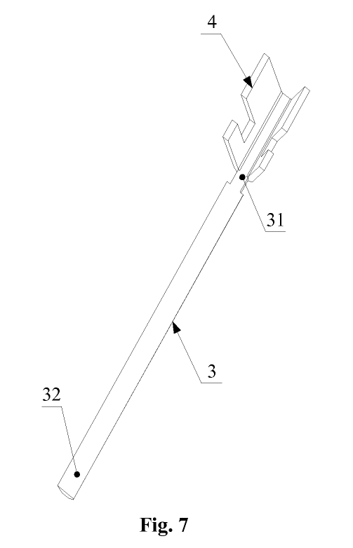

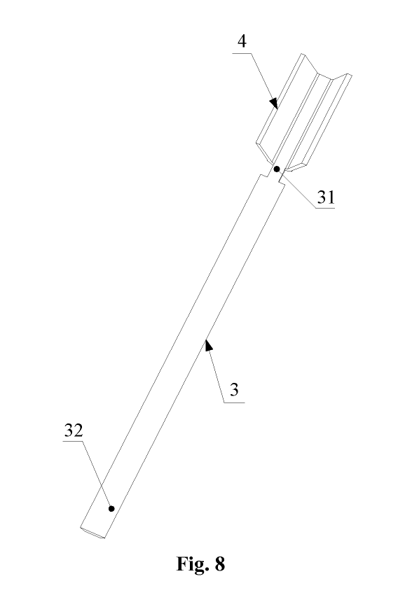

Reference numerals in FIGS. 1 to 8:

electric heating wire 01, lead 02, electrode 03, battery 04, copper sheet 05;

electric heating wire 1, electrode 2, conductor 3, wing piece 4, riveting section 31, extending section 32.

### DETAILED DESCRIPTION

There is provided in the present application an electronic cigarette which could further improve an emission evenness of smoke.

Hereinafter, in conjunction with the drawings in embodiments of the present application, technical solutions in the embodiments of the present application will be described clearly and fully. Apparently, the embodiments described below are simply a part of, not all of embodiments of the present application. Based on the embodiments described herein, other embodiments obtained by those skilled in the art without any creative work also are deemed to fall within the protection scope of the present application.

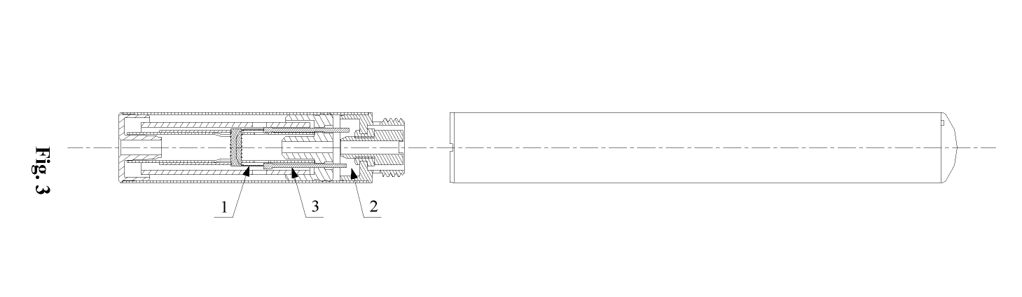

As shown in FIGS. 3 to 8, an electric heating wire 1, an electrode 2, and a conductor 3 electrically conducting the electric heating wire 1 with the electrode 2 are included, wherein the conductor 3 is fixed to the electric heating wire 1 by way of riveting.

In the electronic cigarette according to this embodiment, the electric heating wire 1 is electrically conducted to the electrode 2 by using only the conductor 3, and the electric heating wire 1 and the conductor 3 are electrically conducted with each other by riveting, instead of using a copper sheet and a lead with smaller volumes. Such connection is firmer, so that a phenomenon of an unstable value of resistance in the circuit is avoided, and emission of smoke becomes more even.

In order to further optimize the above technical solution, in the electronic cigarette according to the embodiment, the conductor 3 is a strip-shaped or rod-shaped conductor and also has a riveting section 31 provided with two wing pieces 4 and connected to the electric heating wire 1. The two wing pieces 4 are provided symmetrically and both have a same structure. In this embodiment, in order to connect the electric heating wire 1 to the conductor 3 conveniently, and in order to reduce an occurring probability of poor contact, it is preferable in the present embodiment that the riveting section 31 connected to the electric heating wire 1 is provided with two wing pieces 4, so as to increase the connecting area. The two wing pieces 4 are provided symmetrically, and do not lie in the same plane. Specifically, the two wing pieces 4 are provided in V-shape on the riveting section 31, that is, there exists an angle between the two wing pieces, and the angle is ranged from 20 degrees to 80 degrees, so as to further optimize the effect of the connection.

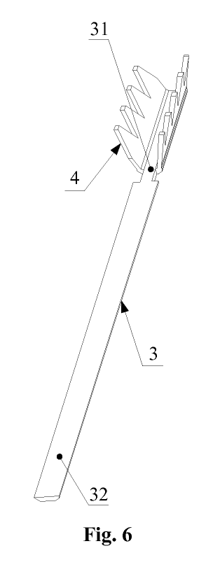

Specifically, the wing piece 4 may be of a tooth-shaped, notch-shaped (that is, a flat plate with a polygonal notch, and preferably, with a rectangular notch in this embodiment) or plate-shaped structure. As shown in FIGS. 6 to 8, the structure of the wing piece 4 mainly functions to avoid poor contact and facilitate riveting the electric heating wire 1, and thus may be in various forms on condition that working requirements are not influenced, and will not be limited herein.

Preferably, the conductor 3 is a metal sheet or a metal tube. When the conductor 3 is the metal sheet, a thickness of the metal sheet is preferably ranged from 0.1 millimeter to 0.5 millimeter. Such structure of the conductor 3 is relatively common in practical production, and is convenient for purchasing or processing accessories, which provides convenience to the implementation of technical solutions. When the conductor 3 is a copper tube, the two wing pieces 4 are symmetrical with respect to the axis of the copper tube. When the conductor 3 is a copper sheet, the two wing pieces 4 are symmetrical with respect to the center line of the copper plate. In FIGS. 6 to 8, examples in which the conductor is a copper sheet are shown. Specifically, the conductor 3 may be made of metal material such as copper, aluminum, copper alloy, aluminum alloy, iron, zinc, silver, gold, tin or nickel, preferably being made of copper.

In this present embodiment, the conductor 3 is fixed to the riveting section 31 of the electric heating wire 1 by way of riveting, and an extending section 32 of the conductor 3 is connected to the electrode 2 by way of welding or interference fit. Such connection is operated conveniently, and is very firm, without influence on production efficiency of the electronic cigarette. Certainly, the conductor 3, the electric heating wire 1 and the electrode 2 may be connected in any other manner, for example clamping, etc, on condition that there is no influence on normal electrical conduction between the conductor 3 and the electric heating wire 1 as well as the electrode 2.

The embodiments of the present description have been described in progressive manner, and every embodiment focuses on illustrating differences from one another. Identical and similar parts between the embodiments may be referred to mutually.

The forgoing description of the embodiments disclosed enables those skilled in the art to implement or use the present application. Various modifications to these embodiments may be apparent to those skilled in the art, and the general principle defined in the present application could be implemented in other embodiments without departing from the spirit or the scope of the present application. Therefore, the present application will not be limited to the embodiments shown in the present application, but conforms to a broadest scope consistent with the principle and novel features disclosed herein.

1. An electronic cigarette, comprising an electric heating wire, an electrode, and a conductor electrically conducting the electric heating wire with the electrode, wherein the electric heating wire and the conductor are connected by way of riveting.

2. The electronic cigarette according to claim 1, wherein the conductor is a strip-shaped or rod-shaped conductor, and has a riveting section provided with two wing pieces and connected to the electric heating wire, and the two wing pieces are provided symmetrically and have a same structure.

3. The electronic cigarette according to claim 2, wherein the wing piece is a tooth-shaped wing piece.

4. The electronic cigarette according to claim 2, wherein the wing piece is a notch-shaped wing piece.

5. The electronic cigarette according to claim 2, wherein the wing piece is a plate-shaped wing piece.

6. The electronic cigarette according to claim 2, wherein the two wing pieces are provided in a V-shape on the conductor, and form therebetween an angle ranged from 20 degrees to 80 degrees.

7. The electronic cigarette according to claim 1, wherein the conductor is a metal sheet or a metal tube, and wherein, in the case of the metal sheet, the conductor has a thickness ranged from 0.1 millimeter to 0.5 millimeter.

8. The electronic cigarette according to claim 1, wherein the conductor has an extending section connected to the electrode by way of welding or interference fit.

9. The electronic cigarette according to claim 2, wherein the conductor has an extending section connected to the electrode by way of welding or interference fit.

10. The electronic cigarette according to claim 3, wherein the conductor has an extending section connected to the electrode by way of welding or interference fit.

11. The electronic cigarette according to claim 4, wherein the conductor has an extending section connected to the electrode by way of welding or interference fit.

12. The electronic cigarette according to claim 5, wherein the conductor has an extending section connected to the electrode by way of welding or interference fit.

13. The electronic cigarette according to claim 6, wherein the conductor has an extending section connected to the electrode by way of welding or interference fit.

14. The electronic cigarette according to claim 7, wherein the conductor has an extending section connected to the electrode by way of welding or interference fit.
